(19) United States
(12) Patent Application Publication
(10) Pub. No.: US 2010/0209814 A1
(43) Pub. Date: Aug. 19, 2010

(54) COMPOSITE CATALYST AND PRODUCING METHOD THEREOF

(75) Inventors: Shuichi SUZUKI, Hitachi (JP); Jun Kawaji, Hitachi (JP); Yoshiyuki Takamori, Hitachinaka (JP); Makoto Morishima, Hitachinaka (JP); Hideo Daimon, Tsukubamirai (JP); Taigo Onodera, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/707,112

(22) Filed: Feb. 17, 2010

(30) Foreign Application Priority Data
Feb. 17, 2009 (JP) 2009-033338

(51) Int. Cl. H01M 8/10; B01J 27/02; B01J 27/24; B01J 27/20; B01J 27/047; B01J 27/051; B01J 27/045

(52) U.S. Cl. 429/483; 502/216; 502/200; 502/174; 502/219; 502/220; 502/223

(57) ABSTRACT

There is provided a composite catalyst in which metal particles having catalytic activity are supported at a high density on a surface of an inorganic oxide, and the supported metal particles are strongly fixed to the surface of the inorganic oxide to improve the durability of the composite catalyst.

The composite catalyst includes the inorganic oxide and the metal particles. A compound having a functional group including an amino group or a thiol group is bonded to a surface of the inorganic oxide. The metal particles are bonded to the functional group.

### CLAIM OF PRIORITY

The present application claims priority from Japanese Patent application serial No. 2009-33338, filed on Feb. 17, 2009, the content of which is hereby incorporated by reference into this application.

### BACKGROUND OF THE INVENTION

1. Field of the Invention

The present invention relates to a composite catalyst and a producing method thereof.

2. Description of Related Art

The recent advancement of an electronic technology has increased an amount of information. Since the increased information needs to be processed at a higher speed with higher functionality, a high-output-density and high-energy-density power source, i.e., a power source having a long continuous run time has been required.

There is a growing need for a small-size power generator which does not require charging, i.e., a micro power generator easily suppliable with fuel. Against such a backdrop, a fuel cell has been examined as a promising candidate.

The fuel cell is a power generator which includes at least a solid or liquid electrolyte, and two electrodes (an anode and a cathode) for inducing a desired electrochemical reaction, and directly converts a chemical energy possessed by the fuel to an electric energy with a high efficiency.

A fuel cell using a solid polymer electrolyte membrane as an electrolyte and using hydrogen as a fuel is called a polymer electrolyte fuel cell (PEFC), while a fuel cell using methanol as the fuel is called a direct methanol fuel cell (DMFC).

For each of the PEFC and the DMFC, an improvement in the durability thereof is one of tasks to be achieved and, in particular, an improvement in the durability of a composite catalyst used in the electrodes is required.

As a catalyst for the PEFC or the DMFC, particles of a precious metal, such as platinum, are typically used, and supported on a carbon support as necessary to be used. However, in case that a catalytic metal is directly supported on the carbon support, the carbon support is corroded by catalysis of the catalytic metal and extinct. As a result, the catalytic metal particles that have lost the support are aggregated so that the effective surface area thereof is reduced undesirably.

In Patent Literature 1 (Japanese Patent Laid-open No. 2004-363056), there is disclosed a catalyst supporting electrode for a polymer electrolyte fuel cell in which an anticorrosive metal oxide supporting catalytic metal fine particles is dispersedly supported on a surface of a conductive support.

In Patent Literature 2 (Japanese Patent Laid-open No. 1993-174838), there is disclosed a technique for forming a support structure of a platinum group catalyst having a large catalyst specific surface area made by soaking a metal oxide layer formed around a catalyst support base material by a thermal decomposition method in a chloride solution of the platinum group.

### SUMMARY OF THE INVENTION

It is an object of the present invention to provide a composite catalyst having improved durability, wherein metal particles having catalytic activity are supported at a high density on a surface of a metal oxide (hereinafter, it is also called an inorganic oxide), and the supported metal particles are strongly fixed to the surface of the metal oxide.

A composite catalyst includes a metal oxide (an inorganic oxide) and a catalytic metal, wherein a compound having a functional group including an amino group or a thiol group is bonded to a surface of the metal oxide, and the catalytic metal is bonded to the functional group.

### BRIEF DESCRIPTION OF THE DRAWINGS

FIG. 1 is a schematic cross-sectional view showing an example of a structure of a composite catalyst according to the present invention.

FIG. 2 is a schematic cross-sectional view showing another example of the structure of the composite catalyst according to the present invention.

FIG. 3 is a schematic cross-sectional view showing a microscopic structure of the composite catalyst according to the present invention.

FIG. 4 is a molecular structure view on a surface of a metal oxide showing an embodiment according to the present invention.

FIG. 5 is a molecular structure view on a surface of a metal oxide showing another embodiment according to the present invention.

FIG. 6 is a STEM image showing a platinum supporting titania of Embodiment 1 according to the present invention.

FIG. 7 is a STEM image showing a platinum supporting titania of Embodiment 2 according to the present invention.

FIG. 8 is a STEM image showing a platinum supporting titania of Comparative Example 1.

FIG. 9 is a schematic cross-sectional view showing a fuel cell of an embodiment according to the present invention.

FIG. 10 is a schematic cross-sectional view showing a mobile information terminal on which the fuel cell of the embodiment according to the present invention is mounted.

### DETAILED DESCRIPTION OF THE PREFERRED EMBODIMENTS

A fuel cell includes a membrane electrode assembly (MEA) including an anode, an electrolyte membrane, a cathode, and a gas diffusion layer, in which the anode oxidizes fuel, and the cathode reduces oxygen. A composite catalyst according to the present invention relates to a composite catalyst used in such a fuel cell.

Note that, hydrogen or methanol is used as the fuel for the fuel cell. On the other hand, the use of alkali hydroxide, hydrazine, or dimethyl ether which is a pressure liquefied gas is examined. Air or oxygen is used as an oxidant gas.

The fuel is electrochemically oxidized at the anode, and oxygen is reduced at the cathode. Between the two electrodes, an electrical potential difference is produced. At this time, when a load is placed as an external circuit between the two electrodes, ion transfer occurs in the electrolyte so that electric energy is extracted into the external load.

For this reason, various fuel cells are expected to be applied to a large-scale power generation system, a small-scale distributed cogeneration system, an electric vehicle power system or the like, and the commercial development thereof has been vigorously promoted.

The composite catalyst according to the present invention is a composite catalyst containing a metal oxide and a catalytic metal (a metal having a catalysis or a catalytic activity), wherein a compound having a functional group including an amino group or a thiol group is bonded to a surface of the metal oxide, and the catalytic metal is bonded to the functional group. In other words, it can also be said that the catalytic metal is supported on the metal oxide via the functional group described above.

The composite catalyst according to the present invention is characterized in that the metal oxide is supported on a surface of a carbon-based base material (a carbonaceous base material). Examples of the carbon-based base material include a carbon black, a carbon fiber and an activated carbon, and a carbon-based base material having a large specific surface area is desirable.

Preferably, the metal oxide (the inorganic oxide) is an oxide of at least one metal (one element) selected from the group consisting of titanium, niobium, tantalum, molybdenum, tungsten, silicon, germanium and tin.

Preferably, the catalytic metal is at least one selected from the group consisting of ruthenium, rhodium, palladium, iridium, platinum and gold.

The composite catalyst according to the present invention is also characterized in that the compound having the functional group described above is a silane compound. This can be implemented by bonding a silane compound containing silicon using silane coupling reaction or the like.

The composite catalyst described above can also be applied to an anode oxidizing the fuel and/or a cathode reducing oxygen or, alternatively, to an anode portion and/or a cathode portion of a membrane electrode assembly including an electrolyte membrane having proton conductivity.

A membrane electrode assembly according to the present invention includes the anode described above, the cathode described above and an electrolyte membrane having proton conductivity, and the electrolyte membrane is disposed between the anode described above and the cathode described above.

It is also possible to combine the membrane electrode assembly described above with a constituent member for supplying fuel, a constituent member for supplying air (oxygen), a collector member for outputting generated electricity and the like to form a fuel cell or a fuel cell power generation system.

A method for producing a composite catalyst according to the present invention includes the steps of bonding a compound having a functional group including an amino group or a thiol group to a surface of a metal oxide, bonding a metal complex containing a catalytic metal to the functional group, and reducing the metal complex to the catalytic metal.

It is preferable that the compound containing nitrogen contains nitrogen as an amino group, and the compound containing sulfur contains sulfur as a thiol group.

Hereinbelow, a structure of the composite catalyst according to the present invention will be described with reference to the figures.

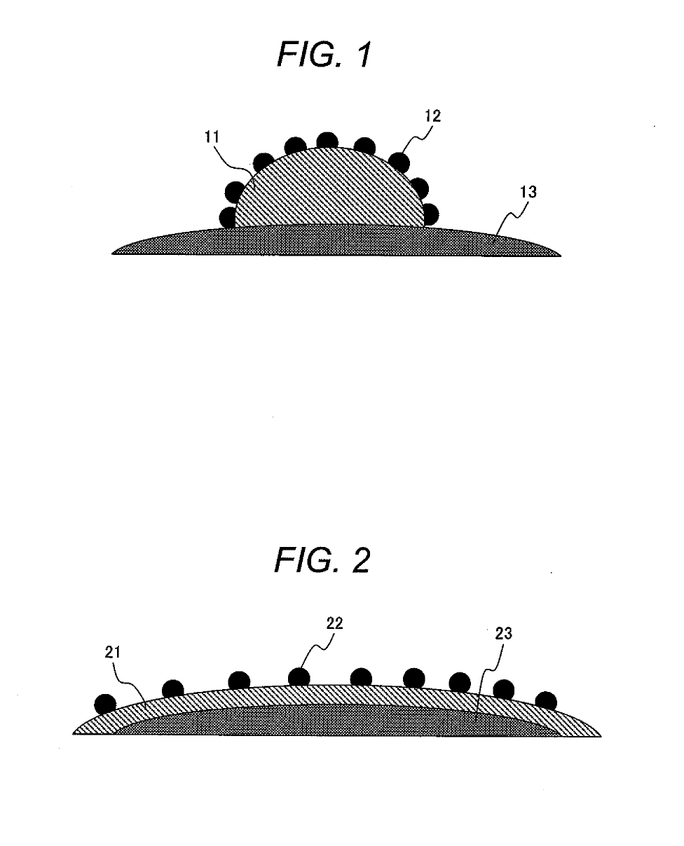

FIG. 1 is a schematic cross-sectional view showing an example of a structure of the composite catalyst according to the present invention.

In the figure, a catalytic metal 12 is supported on a metal oxide 11, and the metal oxide 11 is supported on a carbon (a carbon-based base material or a carbonaceous base material). The catalytic metal 12 may also be supported on the carbon 13, but a largest possible part of the catalytic metal 12 is preferably supported on the metal oxide 11, and at least one half or more of the catalytic metal 12 is preferably supported on the metal oxide 11. This is because the carbon 13 is corroded and extinguished by the catalysis of the catalytic metal 12 when the catalytic metal 12 is supported on the carbon 13. The carbon 13 is not necessarily required but the carbon 13 is preferably used to improve an electron conductivity of the fuel cell since the metal oxide 11 has a low electron conductivity.

FIG. 2 is a schematic cross-sectional view showing another example of the structure of the composite catalyst according to the present invention.

In the figure, a metal oxide 21 has a structure covering carbon 23, and a catalytic metal 22 is supported on the metal oxide 21. It is possible to prevent the catalytic metal 22 from being supported on the carbon 23, and to prevent the corrosion and extinction of the carbon 23 by the catalysis of the catalytic metal 22 with such a structure.

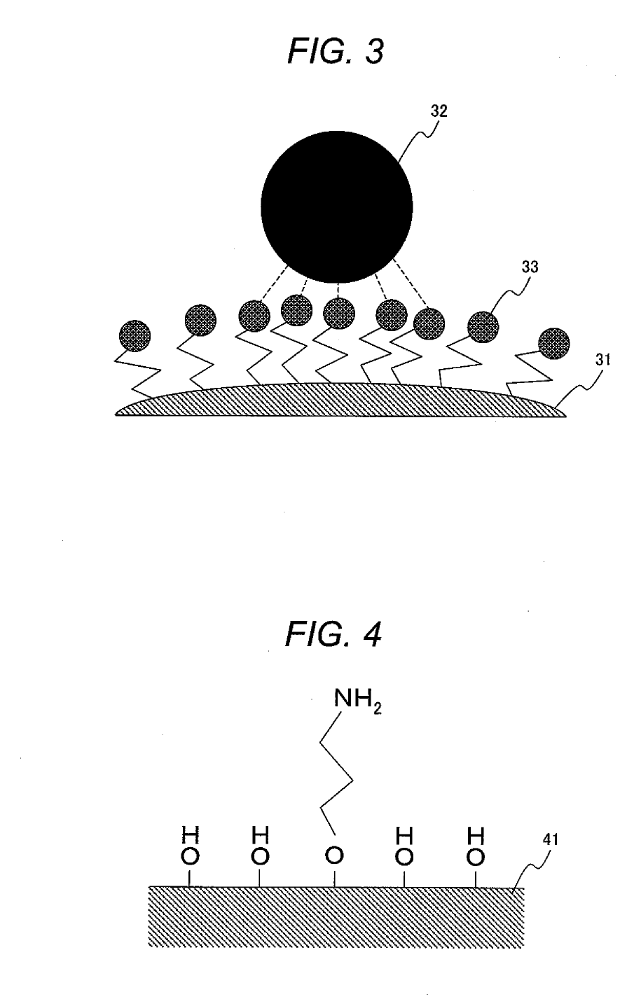

FIG. 3 is a schematic cross-sectional view showing a microscopic structure of the composite catalyst according to the present invention.

In the figure, nitrogen 33 (or sulfur) having a strong bonding force with a catalytic metal 32 is adhered onto a metal oxide 31. Particles of the catalytic metal 32 are fixed onto the metal oxide 31 by such a structure, and the aggregation of the catalytic metal 32 can be prevented.

As a means for causing the nitrogen 33 (or sulfur) to be adhered onto the metal oxide 31, there is a modification of a surface of the metal oxide 31 with a compound containing nitrogen or sulfur. Here, nitrogen or sulfur is preferably present at a terminal of the compound.

As examples of the compound containing nitrogen at the terminal thereof, there can be listed a compound having an amino group, a compound having a nitro group and the like. However, it is preferable to use a compound having an amino group in terms of a bonding property with the catalytic metal 32.

As examples of the compound containing sulfur at the terminal thereof, there can be listed a compound having a thiol group, a compound having a sulfone group and the like. However, it is preferable to use a compound having a thiol group in terms of the bonding property with the catalytic metal 32.

As means for modifying the surface of the metal oxide 31 with any of the compounds mentioned above, it is effective to use a hydroxyl group which is present in extremely large number on the surface of the metal oxide 31. Preferably, a compound bondable to the hydroxyl group is used. For example, as a compound having an amino group, there can be used 3-bromopropylamine or the like. As a compound having a thiol group, there can be used 3-chloro-1-propanethiol or the like. In each of the compounds mentioned above, the length of an alkyl chain is not particularly limited, but preferably the number of carbon atoms is about three.

FIG. 4 is a molecular structure view on a surface of a metal oxide showing an embodiment according to the present invention.

The figure shows a molecular structure in case of using 3-bromopropylamine having the amino group. The surface of the metal oxide 41 is modified with a compound having the amino group by causing a reaction between a hydroxyl group present on a surface of a metal oxide 41 and bromine.

It is possible to effect an easier modification by using a silane coupling agent having the amino group or the thiol group. This is because the hydroxyl group on the surface of the metal oxide 41 and a silanol group resulting from the hydrolysis of the silane coupling agent are easily bonded to each other.

Examples of the silane coupling agent having the amino group include N-2-aminoethyl-3-aminopropylmethyldimethoxysilane, N-2-aminoethyl-3-aminopropyltrimethoxysilane, N-2-aminoethyl-3-aminopropyltriethoxysilane, 3-aminopropyltrimethoxysilane, and 3-aminopropyltriethoxysilane. Examples of the silane coupling agent having the thiol group include 3-mercaptopropylmethyldimethoxysilane, and 3-mercaptopropylmethoxysilane. In case of using the silane coupling agent, it follows that silicon is present on the surface of the metal oxide 41.

Here, in terms of durability, bonding via silicon is preferred since it allows stable bonding of a modification group containing nitrogen or sulfur.

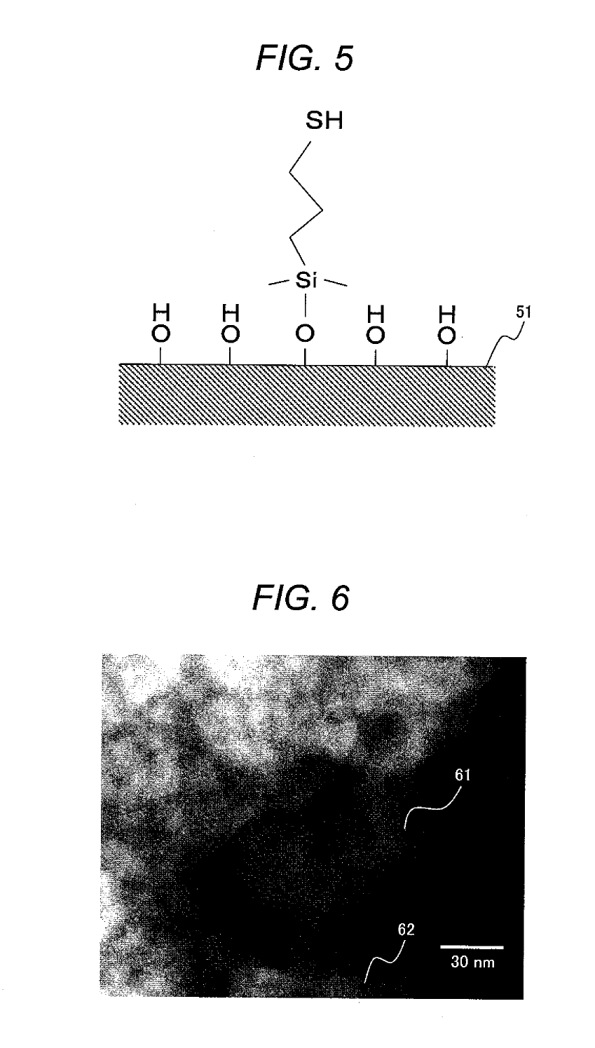

FIG. 5 is a molecular structure view on a surface of a metal oxide showing another embodiment according to the present invention.

The figure shows a molecular structure in case of using 3-mercaptopropylmethoxysilane having a thiol group. A surface of a metal oxide 51 is modified with a compound having the thiol group by causing reaction between a hydroxyl group present on the surface of the metal oxide 51 and a silanol group resulting from the hydrolysis of 3-mercaptopropylmethoxysilane.

Here, as the metal oxide 51 (the inorganic oxide) according to the present invention, it is preferable to use an oxide of at least one metal (one element) selected from the group consisting of titanium, niobium, tantalum, molybdenum, tungsten, silicon, germanium and tin. These metals are preferable since the elution thereof is less likely to occur even when an acidic electrolyte is used in the fuel cell.

Note that titanium, niobium, tantalum, molybdenum, tungsten, germanium and tin being constituents of the inorganic oxide belong to a metal (a metallic element). On the other hand, silicon being constituents of the inorganic oxide belongs to a nonmetal (a nonmetallic element). The inorganic oxide is a general term for oxides of these elements (the metallic element and nonmetallic element).

When the elution of the metal has occurred, an eluted metal cation is undesirably bonded to an ion exchange group in the electrolyte to inhibit the transfer of a proton, and reduce the output of the fuel cell.

Preferably, the catalytic metal in the present invention is at least one selected from the group consisting of ruthenium, rhodium, palladium, iridium, platinum and gold. In particular, in the case where the catalytic metal is used as an anode composite catalyst for a DMFC or as an anode composite catalyst for a PEFC using hydrogen containing carbon monoxide as a fuel, it is more preferable to use a platinum-ruthenium alloy as the catalytic metal in terms of catalytic activity. In case that the catalytic metal is used as a cathode composite catalyst for a DMFC or PEFC or as an anode composite catalyst for a PEFC using hydrogen not containing carbon monoxide as the fuel, it is more preferable to use platinum as the catalytic metal.

In order to fix the catalytic metal onto the metal oxide 51, it is necessary for nitrogen or sulfur to be present on the surface of the metal oxide 51. Even when nitrogen or sulfur is present inside the metal oxide 51, effects intended by the present invention are not obtainable.

An amount of nitrogen or sulfur present on the surface of the metal oxide 51 can be measured by comparing the composition of the entire composite catalyst with the composition of the surface thereof. For example, there is a method which compares the composition of the entire composite catalyst determined by X-ray fluorescence analysis with the composition of the surface of the composite catalyst determined by X-ray photoelectronic spectroscopic analysis.

Likewise, in case of bonding a modification group containing nitrogen or sulfur via silicon, even when silicon is present inside the metal oxide 51, the effects intended by the present invention are not obtainable.

In case of using an oxide of silicon as the metal oxide 51, it is difficult to distinguish silicon inside the metal oxide 51 from silicon derived from a silane coupling agent. In either case, however, bonding to a modification group containing nitrogen or sulfur intended by the present invention can be effected so that no problem arises.

Next, a description will be given of a method of producing the composite catalyst according to the present invention.

The method of producing the composite catalyst according to the present invention can be subdivided into the following two methods.

In one of the methods, the catalytic metal is first supported on (the surface of) the metal oxide, and then the metal oxide and the catalytic metal are supported on carbon.

In the other method, the metal oxide is first supported on (the surface) of the carbon, and then the catalytic metal is supported on (the surface) of the metal oxide.

In the former method, the catalytic metal is first supported on the metal oxide so that the catalytic metal is not supported on the carbon. This allows more effective prevention of the corrosion of the carbon by the catalytic metal.

In the latter method, on the other hand, the metal oxide is first supported on the carbon. This allows high dispersion of the metal oxide over the carbon.

Since the metal oxide is lower in electron conductivity than carbon, an energy loss is likely to occur when electrons generated in reaction on the catalytic metal transfer. Accordingly, it is necessary to minimize the size and thickness of the metal oxide supported on the carbon, and to minimize the distance over which the electrons transfer in the metal oxide. The latter method is advantageous over the former method in that it can minimize the size and thickness of the metal oxide supported on the carbon.

The method in which the catalytic metal is supported on the metal oxide, and then the metal oxide and the catalytic metal are supported on the carbon will be illustrated more specifically.

First, the metal oxide is produced. Here, it is preferable to produce the metal oxide so as to maximize the specific surface area thereof. This is for allowing a larger amount of the catalytic metal to be supported on the metal oxide per unit weight, and minimizing the thicknesses of electrodes and an energy loss resulting from substance transfer when a desired amount of the catalytic metal is to be contained in the electrodes of the fuel cell. To this end, the metal oxide is preferably formed into fine particles or a porous structure having a large specific surface area. The fine particles of the metal oxide can be obtained by, e.g., dispersing a metal alcoxide in an alcohol solvent, adding water to the resultant mixture while stirring it, hydrolyzing the mixture, filtering the resultant solution to remove the solvent, and then sintering the remaining substance in atmospheric air.

Next, the compound containing nitrogen or sulfur is bonded to the surfaces of the oxide particles.

For example, in case of using the compound containing nitrogen, the metal oxide particles are dispersed in an aqueous alcohol solution, and 3-bromopropylamine is added thereto to be bonded to hydroxyl groups on the metal oxide. The amount of 3-bromopropylamine added herein is preferably about 1 to 3 times the amount of the hydroxyl groups on the surface of the metal oxide.

Note that the amount of the hydroxyl groups on the metal oxide may be smaller when a sintering temperature in atmospheric air is high. In that case, the amount of the hydroxyl groups on the metal oxide can be increased by dispersing the metal oxide particles in about several percents of aqueous hydrogen peroxide. After the amino groups are thus introduced to the surface of the metal oxide, the metal oxide particles are mixed with a catalytic metal complex in the aqueous solution such that the catalytic metal complex is bonded to the amino groups on the surface of the metal oxide.

The type of the catalytic metal complex is not particularly limited. In case of platinum, there can be used hexachloroplatinate, potassium hexachloroplatinate, sodium hexachloroplatinate, tetrachloroplatinate, potassium tetrachloroplatinate, sodium tetrachloroplatinate, tetraammine platinum chloride, dinitrodiamine platinum or the like. Preferably, a chloride such as hexachloroplatinate, sodium hexachloroplatinate, potassium hexachloroplatinate, tetrachloroplatinate, potassium tetrachloroplatinate, or sodium tetrachloroplatinate is used since it is easily bonded to nitrogen or sulfur introduced to the surface of the metal oxide. More preferably, a bivalent platinum chloride such as tetrachloroplatinate, potassium tetrachloroplatinate, or sodium tetrachloroplatinate is used.

After bonding the catalytic metal complex to the amino groups fixed on the surface of the metal oxide, an excessive part of the catalytic metal complex is removed by filtration or the like. In case that nitrogen or sulfur is present on the surface of the metal oxide as in the present invention, a larger amount of the catalytic metal complex can be bonded to the surface of the metal oxide.

Next, the catalytic metal complex bonded to the surface of the metal oxide is reduced to a metallic state. As a method for the reduction, e.g., a method which uses a reductant such as sodium borohydride, formaldehyde or hypophosphorous acid, or a method which performs a heat treatment under a hydrogen atmosphere is selected.

In this manner, a substance in which the catalytic metal is supported on the surfaces of the metal oxide particles containing nitrogen is obtained and the composite catalyst according to the present invention is obtained by mixing the substance with the carbon. As the carbon, a carbon black or a carbon fiber can be used herein. Preferably, a carbon having a specific surface area of 10 to 2000 m²/g is used.

Thus, in the composite catalyst synthesized, the catalytic metal is entirely supported on the metal oxide. As a result, it is possible to minimize the corrosion of carbon by the catalytic metal.

Next, the method in which the metal oxide is first supported on the carbon, and then the catalytic metal is supported on the metal oxide will be illustrated.

When the metal oxide is to be supported on the carbon, the metal oxide is preferably formed into fine particles or a porous structure so as to maximize the specific surface area of the composite catalyst in the same manner as in the case described above. As a method for causing the metal oxide to be supported on the carbon, there is used a method which, e.g., disperses the carbon and a metal alkoxide into an alcohol solvent, and then adds water to the resultant mixture while stirring the mixture to hydrolyze the metal alcoxide. Thereafter, the solvent is removed by filtration, and the remaining substance is sintered in atmospheric air, whereby the metal oxide supported on the carbon can be obtained.

Alternatively, the metal oxide supported on carbon can also be obtained by drying/sintering the carbon impregnated with an aqueous alcohol solution containing metal salt after impregnating the carbon with the aqueous alcohol solution. The method of fixing the metal oxide to the carbon in advance allows a high-density dispersion of the minute metal oxide particles. The method is preferred because it reduces a transferring distance of electrons in the metal oxide having a low electron conductivity when the electrons transfer from/to the catalytic metal supported on the metal oxide.

Next, a description will be given of a method for introducing nitrogen or sulfur to the surface of the metal oxide supported on the carbon.

The description will be given using the case of introducing sulfur, and bonding the sulfur via silicon as an example.

The carbon having the metal oxide supported thereon is dispersed in an aqueous alcohol solution. 3-mercaptopropylmethoxysilane is added to the solution and bonded to hydroxyl groups on the metal oxide by the silane coupling reaction, whereby the thiol groups are introduced to the surface of the metal oxide. The amount of 3-mercaptopropylmethoxysilane added herein is preferably about 1 to 3 times the amount of the hydroxyl groups on the surface of the metal oxide.

In the case described above, 3-mercaptopropylmethoxysilane is bonded not only to the hydroxyl groups on the surface of the metal oxide, but also to hydroxyl groups on the surface of the carbon. However, since the density of the hydroxyl groups present on the surface of the carbon is lower by about one order of magnitude than the density of the hydroxyl groups present on the surface of the metal oxide, a majority of the thiol groups introduced herein are adhered to the surface of the metal oxide. After the thiol groups are thus introduced to the surface of the metal oxide, the metal oxide particles are mixed with a catalytic metal complex in the aqueous solution such that the catalytic metal complex is bonded to the thiol groups on the surface of the metal oxide.

Thereafter, an excessive part of the catalytic metal complex is removed by filtration so that the catalytic metal complex bonded to the surface of the metal oxide is reduced to a metallic state. In this manner, the composite catalyst according to the present invention can be obtained in which the metal oxide particles containing sulfur and silicon are supported on the carbon, and the catalytic metal is supported on the metal oxide.

A ratio between the metal oxide and the carbon in the composite catalyst according to the present invention is not particularly limited, and a volume ratio therebetween is preferably in a range of about 1:99 to 1:1. This is because the ratio of the catalytic metal supported on the surface thereof to the entire composite catalyst is consequently reduced when the amount of the metal oxide is excessively small, and the electron conductivity in the electrodes of the fuel cell is reduced when the amount of the metal oxide is excessively large.

Hereinbelow, the method of producing the composite catalyst according to the present invention will be shown specifically.

### Embodiment 1

3.0 g of titania (TiO₂) having a specific surface area of 125 m²/g was added to 300 ml of an aqueous 95 vol % 2-propanol solution, and the resultant mixture was stirred at a room temperature for 10 minutes. 1.9 g of 3-mercaptopropylmethoxysilane was added to the mixture, and the mixture was stirred at 50° C. for 2 hours.

Thereafter, the mixture was filtered, and the remaining substance was cleaned with 2-propanol, and dried in atmospheric air at 100° C. for 12 hours, whereby a substance in which the surface of titania was modified with thiol groups via silicon was obtained.

Using energy dispersive X-ray fluorescence spectroscopy (EDX system: Genesis™ commercially available from EDAX Inc.) and X-ray photoelectronic spectroscopy (XPS system: AXIS-HS™ commercially available from Simadzu/KRATOS Limited), composition analysis was performed with respect to each of elements in the substance. The result of the composition analysis is shown in Table 1. The compositions in the result of the analysis are shown on the assumption that the total sum of titanium, silicon and sulfur is 100 at %.

TABLE 1

| | Ti | Si | S |
|---|---|---|---|
| Method of Analysis | (at %) | (at %) | (at %) |
| EDX (Overall Analysis) | 90.6 | 5.7 | 3.6 |
| XPS (Surface Analysis) | 80.2 | 10.1 | 9.7 |

As shown in Table 1, silicon and sulfur are at higher concentrations in the surface analysis than in the overall analysis, and more of silicon and sulfur are present on the surface of titania.

Next, 0.5 g of titania having thiol groups, which had been obtained herein, was added to 50 ml of ion exchange water, and the resultant mixture was stirred at a room temperature for 10 minutes. 50 ml of ion exchange water containing 0.47 g of potassium tetrachloroplatinate was added to the mixture, and the mixture was stirred at 70° C. for 2 hours, whereby platinum was bonded to the thiol groups. Thereafter, the mixture was filtered, and the remaining substance was cleaned with ion exchange water so that a complex of platinum that had not been bonded to the thiol groups was removed.

After the obtained substance was dried in vacuo, a reduction treatment was performed at 150° C. for 3 hours, while allowing the passage of an argon gas containing 3% of hydrogen using a tube furnace, thereby reducing the complex of platinum bonded to the thiol groups into a metallic state.

The obtained substance was observed using a scanning transmission electron microscope (STEM: HD-2000™ commercially available from Hitachi, Ltd.). FIG. 6 shows an image obtained by the observation, which is a Z-contrast image (ZC image).

From the figure, it can be seen that platinum particles 61 having diameters in the range of 1.0 to 1.5 nm were supported at an extremely high density on titania 62.

Using an inductive coupled plasma-atomic emission spectrometer (ICP optical emission spectrometer: ULTIMA-2™ commercially available from HORIBA Ltd.), the amount of supported platinum was analyzed, which was 9.2 wt %. Since the specific surface area of titania is 125 m²/g, the density of the supported platinum relative to the surface area of titania is 811 μg/m².

The substance thus obtained was mixed with a carbon block, whereby the composite catalyst according to the present invention was obtained.

Table 2 shows the result of composition analysis performed by the XPS with respect to the substance before it was mixed with the carbon black. The substance mentioned above contains titanium and oxygen being constituent elements of the metal oxide, platinum being the catalytic metal, silicon and sulfur.

TABLE 2

| Pt | Ti | Si | S | N | O | C |
|---|---|---|---|---|---|---|
| (at %) | (at %) | (at %) | (at %) | (at %) | (at %) | (at %) |
| 2.4 | 18.2 | 2.0 | 1.4 | — | 53.2 | 22.7 |

### Embodiment 2

3.0 g of titania having a specific surface area of 125 m²/g was added to 300 ml of an aqueous 95 vol % 2-propanol solution, and the resultant mixture was stirred at a room temperature for 10 minutes. 1.7 g of 3-aminopropyltrimethoxysilane was added to the mixture, and the mixture was stirred at 50° C. for 2 hours. Thereafter, the mixture was filtered, and the remaining substance was cleaned with 2-propanol, and dried in atmospheric air at 100° C. for 12 hours, whereby a substance in which the surface of titania was modified with amino groups via silicon was obtained.

Composition analysis was performed with respect to the substance using the XPS. The result of the composition analysis is shown in Table 3. The compositions in the result of the analysis are shown on the assumption that the total sum of titanium, silicon and sulfur is 100 at %.

TABLE 3

| | Ti | Si | N |
|---|---|---|---|
| Method of Analysis | (at %) | (at %) | (at %) |
| XPS (Surface Analysis) | 78.4 | 11.1 | 10.5 |

As shown in Table 3, it can be seen that the same amounts of nitrogen and silicon as in case of sulfur shown in Table 1 of Embodiment 1 were adhered.

The substance was also analyzed using the ICP optical emission spectrometer, and the composition of silicon was examined, which was 2.0 wt %. Since the specific surface area of titania is 125 m²/g, the density of silicon relative to the surface area of titania is 160 μg/m².

Next, 0.5 g of titania having amino groups, which had been obtained herein, was added to 50 ml of ion exchange water, and the resultant mixture was stirred at a room temperature for 10 minutes. A solution prepared by dissolving 0.47 g of potassium tetrachloroplatinate in 50 ml of ion exchange water was added to the mixture, and the mixture was stirred at 70° C. for 2 hours, whereby a platinum complex was bonded to the amino groups. Thereafter, the mixture was filtered, and the remaining substance was cleaned with ion exchange water so that the platinum complex that had not been bonded to the amino groups was removed.

After the obtained substance was dried in vacuo, a reduction treatment was performed at 150° C. for 3 hours, while allowing the passage of an argon gas containing 3% of hydrogen using a tube furnace, thereby reducing the platinum complex bonded to the amino groups into a metallic state.

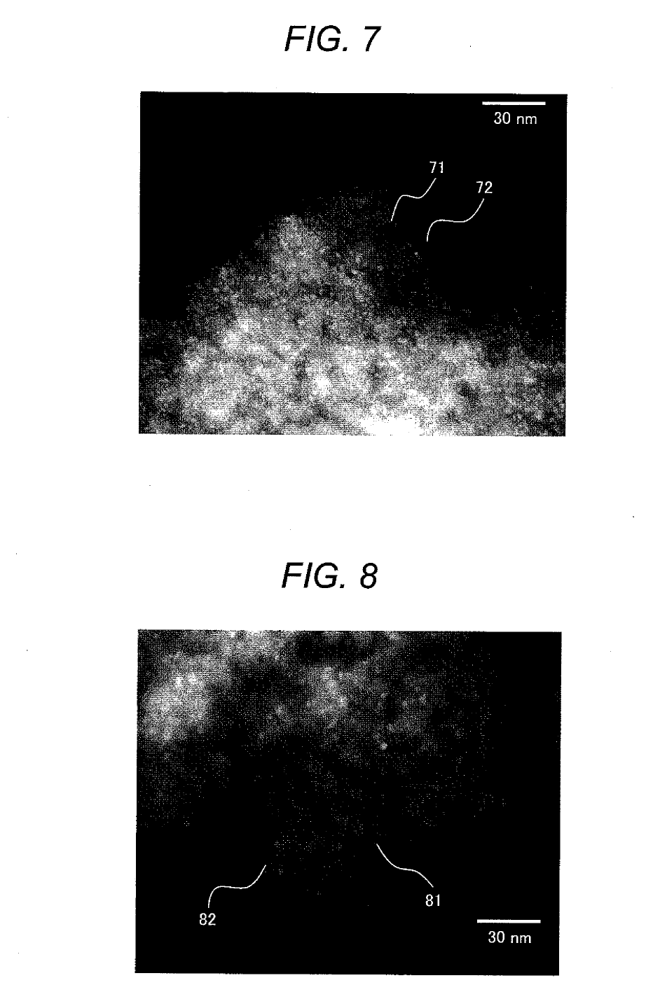

The obtained substance was observed using the STEM. FIG. 7 shows an image obtained by the observation.

Platinum particles 71 having diameters in the range of 2.0 to 2.5 nm were supported at an extremely high density on titania 72. The amount of supported platinum was also analyzed using the ICP optical emission spectrometer, which was 6.8 wt %. Since the specific surface area of titania is 125 m²/g, the density of the supported platinum relative to the surface area of titania is 580 μg/m².

The substance thus obtained was mixed with a carbon block, whereby the composite catalyst according to the present invention was obtained.

The result of composition analysis performed by the. XPS with respect to the substance before it was mixed with the carbon black is as shown in Table 4. The substance contains titanium and oxygen being constituent elements of the metal oxide, platinum being the catalytic metal, silicon and nitrogen.

TABLE 4

| Pt | Ti | Si | S | N | O | C |
|---|---|---|---|---|---|---|
| (at %) | (at %) | (at %) | (at %) | (at %) | (at %) | (at %) |
| 1.7 | 24.6 | 1.5 | — | 1.1 | 60.9 | 10.2 |

### Comparative Example 1

0.5 g of titania having a specific surface area of 125 m²/g was added to 50 ml of ion exchange water, and the resultant mixture was stirred at a room temperature for 10 minutes. A solution prepared by dissolving 0.47 g of potassium tetrachloroplatinate in 50 ml of ion exchange water was added to the mixture, and stirred at 70° C. for 2 hours, whereby a platinum complex was caused to be adsorbed to titania. Thereafter, the mixture was filtered, and the remaining substance was cleaned with ion exchange water, whereby the platinum complex that had not been adsorbed to titania was removed. After the obtained substance was dried in vacuo, a reduction treatment was performed at 150° C. for 3 hours, while allowing the passage of an argon gas containing 3% of hydrogen using a tube furnace, thereby reducing the platinum complex adsorbed to titania into a metallic state.

The obtained substance was observed using the STEM. FIG. 8 shows an image obtained by the observation.

Platinum particles 81 having diameters in the range of 2.5 to 3.0 nm were supported on titania 82, but the density thereof was low. The amount of supported platinum was also analyzed using the ICP optical emission spectrometer, which was 1.0 wt %.

In case of the present comparative embodiment, since the specific surface area of titania is 125 m²/g, the density of supported platinum relative to the surface area of titania is 80 μg/m², which was smaller in amount than in Embodiments 1 and 2. Even if the substance thus obtained is mixed with the carbon black, the amount of the catalytic metal relative to the entire composite catalyst is reduced. Even if the resultant composite catalyst is used in a fuel cell, a high output cannot be obtained.

The result of composition analysis performed by the XPS with respect to the substance before it was mixed with carbon black is as shown in Table 5. From the table, the substance contains titanium and oxygen being constituent elements of the metal oxide, and platinum being the catalytic metal, but does not contain silicon, nitrogen and sulfur.

TABLE 5

| Pt | Ti | Si | S | N | O | C |
|---|---|---|---|---|---|---|
| (at %) | (at %) | (at %) | (at %) | (at %) | (at %) | (at %) |
| 0.4 | 26.0 | — | — | — | 59.5 | 14.1 |

### Comparative Example 2

1.0 g of a carbon black having a specific surface area of 800 m²/g was added to 600 ml of an aqueous 95 vol % 2-propanol solution, and the resultant mixture was stirred at a room temperature for 10 minutes. 3.7 g of 3-aminopropyltrimethoxysilane was added to the mixture, and the mixture was stirred at 50° C. for 2 hours. Thereafter, the mixture was filtered, and the remaining substance was cleaned with 2-propanol, and dried in atmospheric air at 100° C. for 12 hours, whereby a substance in which the surface of the carbon black was modified with amino groups via silicon was obtained.

The substance was also analyzed using the ICP optical emission spectrometer, and the composition of silicon was examined, which was 2.0 wt %. Since the specific surface area of carbon black is 800 m²/g, the density of silicon relative to the surface area of carbon black is 25 μg/m², which was smaller in amount than in case of Embodiment 2. Accordingly, it is considered that the amount of adhered amino groups was also small. Therefore, even if the metal oxide is supported on the carbon black, and then the amino groups are caused to be adhered, a majority of the amino groups are adhered to the surface of the metal oxide. As a result, a major part of the catalytic metal is also supported on the metal oxide.

### Embodiment 3

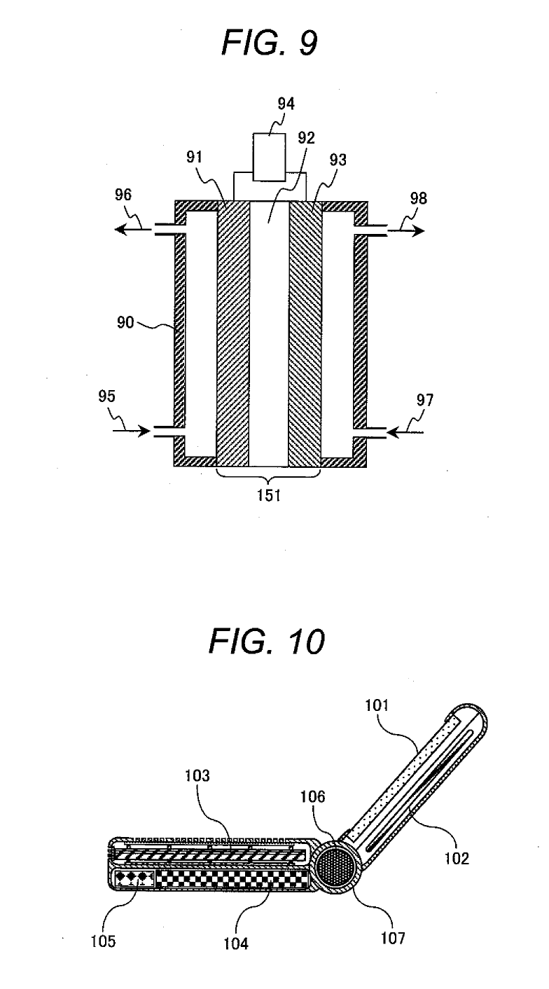

FIG. 9 is a cross-sectional view showing a fuel cell of an embodiment according to the present invention.

The fuel cell has a structure in which an anode 91 including the composite catalyst according to the present invention and an electrolyte binder having proton conductivity, a cathode 93 including the composite catalyst according to the present invention and an electrolyte binder having proton conductivity, and a membrane electrode assembly 151 having a solid polymer electrolyte membrane 92 disposed between the anode 91 and the cathode 93 are contained in a vessel 90.

It is desirable that a gas diffusion layer of carbon paper, carbon cloth or the like not shown is disposed in each of the anode 91 and the cathode 93.

On an operation of the fuel cell, fuel 95 such as hydrogen or methanol is supplied to the anode 91, while an oxidant 97 such as oxygen or air is supplied to the cathode 93. Then, an exhaust gas 96 containing carbon dioxide, unreacted hydrogen or methanol, waste liquid, and the like generated through reaction at the anode 91, and an exhaust gas 98 containing water and an unreacted gas generated through reaction at the cathode 93 are discharged. In addition, generated power is supplied to an external circuit 94 connected to the anode 91 and the cathode 93.

If an acidic material having hydrogen ion conductivity is used for the electrolyte binders used in the anode 91 and the cathode 93 and for the electrolyte membrane 92, the fuel cell can be stably operated without being affected by generated carbon dioxide.

As the material having hydrogen ion conductivity, there can be used a sulfonated fluorine polymer represented by polyperfluorostyrene sulfonic acid, perfluorocarbon sulfonic acid and the like, a material in which a hydrocarbon polymer such as polystyrene sulfonic acids, polyether sulfones and sulfonated polyether ether ketons is sulfonated, or a material in which a hydrocarbon polymer is alkyl sulfonated.

If any of the materials shown above is used for the electrolyte membrane, the fuel cell can be generally operated at a temperature of 80° C. or low.

Further, it is possible to provide a fuel cell capable of operating in a far higher temperature region by using a composite electrolyte membrane in which an inorganic material having hydrogen ion conductivity (proton conductivity), such as tungsten oxide hydrate, zirconium oxide hydrate, or tin oxide hydrate is dispersed microscopically in a heat-resistant resin or a sulfonated resin or the like.

In case of a DMFC, an electrolyte membrane having a low methanol permeability is preferably used since it increases the power utilization rate of fuel.

Likewise, it is also possible to use a solid polymer electrolyte for the binders, and the same material as used for the electrolyte membrane can be used.

As a method for producing the membrane electrode assembly, there is a method comprising the steps of dispersing the composite catalyst according to the present invention and the binder in a solvent, and applying the resultant mixture to the electrolyte membrane by a direct spray method, an inkjet method or the like, a method comprising the steps of applying the mixture to a polytetrafluoroethylene sheet (PTFE sheet) or the like, and sticking the PTFE sheet to the electrolyte membrane by a thermal transfer, or a method comprising the steps of applying the mixture to a gas diffusion layer, and then sticking the gas diffusion layer to the electrolyte membrane.

The membrane electrode assembly or fuel cell thus obtained has a high durability and a high output density.

### Embodiment 4

FIG. 10 shows a mobile information terminal (an example of a fuel cell power generation system) in which the fuel cell according to the present invention is mounted.

The mobile information terminal has a foldable structure, and two folded portions are coupled to each other with a hinge 107 serving also as a holder of a fuel cartridge 106.

In one of the portions, there are embedded a display device 101 integrated with a touch-panel input device, an antenna 102, and the like.

In the other portion, there are embedded a fuel cell 103, a main board 104 having mounted thereon electronic equipment and electronic circuits such as a processor, a volatile memory, a nonvolatile memory, a power control unit, a fuel cell/secondary cell hybrid control unit, and a fuel monitor, a lithium ion secondary cell 105 and the like.

Since the mobile information terminal described above is high in the output density of the fuel cell, the fuel cell 103 can be reduced in size, and provided with a light-weight and compact structure. In addition, since the durability of the fuel cell is high, the mobile information terminal can be used over a long period of time.

The composite catalyst according to the present invention can also be used for another application in which the metal oxide is used as a support for the catalytic metal (i.e., the carbon support is not used). For example, there can be listed a composite catalyst for an exhaust gas purification in a vehicle. The present invention can make adsorbability of the catalytic metal complex to the surface of the metal oxide strong, and make an amount of the adsorbed catalytic metal complex large. Accordingly, the amount of the catalytic metal supported per unit surface area of the metal oxide is increased.

Therefore, when a desired amount of the catalytic metal is to be contained in each of the electrodes of the fuel cell, the thickness of the electrodes can be reduced, the diffusion of fuel being a reactive substance can be improved, and an output of the fuel cell can be increased. In addition, since the adsorbability of the catalytic metal particles to the metal oxide is strong, transfer and aggregation of the catalytic metal particles can be prevented.

The present invention can provide the fuel cell having a high output density and excellent durability by using the composite catalyst in the fuel cell, wherein the catalytic metal particles can be stably supported at a high density on the metal oxide.

The present invention relates to a composite catalyst used in a fuel cell, and the composite catalyst can be used in a polymer electrolyte fuel cell or a direct methanol fuel cell.

What is claimed is:

1. A composite catalyst comprising:
an inorganic oxide; and
a catalytic metal,
wherein a compound having a functional group including an amino group or a thiol group is bonded to a surface of the inorganic oxide, and the catalytic metal is bonded to the functional group.

2. The composite catalyst according to claim 1,
wherein the inorganic oxide is supported on a surface of a carbonaceous base material.

3. The composite catalyst according to claim 1,
wherein the inorganic oxide is an oxide of a element selected from the group consisting of titanium, niobium, tantalum, molybdenum, tungsten, silicon, germanium and tin.

4. The composite catalyst according to claim 1,
wherein the catalytic metal is a metal selected from the group consisting of ruthenium, rhodium, palladium, iridium, platinum and gold.

5. The composite catalyst according to claim 1,
wherein the compound is a silane compound.

6. An anode comprising the composite catalyst according to claim 1.

7. A cathode comprising the composite catalyst according to claim 1.

8. A membrane electrode assembly comprising:
an anode and a cathode comprising a composite catalyst comprising an inorganic oxide and a catalytic metal, wherein a compound having a functional group including an amino group or a thiol group is bonded to a surface of the inorganic oxide, and the catalytic metal is bonded to the functional group; and
an electrolyte membrane having proton conductivity, disposed between the anode and the cathode.

9. A fuel cell comprising:
the membrane electrode assembly according to claim 8;
a constituent member for supplying fuel and oxygen; and
a collector member for outputting generated electricity.

10. A fuel cell power generation system comprising the fuel cell according to claim 9.

11. A method for producing a composite catalyst comprising the steps of:
bonding a compound having a functional group including an amino group or a thiol group to a surface of an inorganic oxide;
bonding a metal complex containing a catalytic metal to the functional group; and
reducing the metal complex to the catalytic metal.
